(19) United States
(12) Patent Application Publication
(10) Pub. No.: US 2024/0388108 A1
(43) Pub. Date: Nov. 21, 2024

(54) SYSTEM AND METHOD FOR POWER DISTRIBUTION

(71) Applicant: R.A. Phillips Industries, Inc., Irvine, CA (US)

(72) Inventor: Gerard DiNardo, South Riding, VA (US)

(21) Appl. No.: 18/664,226

(22) Filed: May 14, 2024

Related U.S. Application Data
(60) Provisional application No. 63/502,446, filed on May 16, 2023.

(51) Int. Cl. H02J 7/00

(52) U.S. Cl. CPC H02J 7/0019; H02J 7/00034; H02J 7/00047; H02J 7/0048; H02J 7/005; H02J 7/007194

(57) ABSTRACT

A power distribution system includes a plurality of battery chargers configured to charge a plurality of batteries and to detect states of charge of the plurality of batteries, and a power distribution circuit (PDC) configured to receive and aggregate electrical power from a plurality of power sources, to receive the states of charge from the battery chargers, and to direct aggregated power to a battery charger of the plurality of battery chargers based on the states of charge from the battery chargers.

### CROSS-REFERENCE TO RELATED APPLICATION(S)

This application claims priority to, and the benefit of, U.S. Provisional Application No. 63/502,446 (“POWER DISTRIBUTION SYSTEM”), filed on May 16, 2023, the entire content of which is incorporated herein by reference.

### FIELD

Aspects of the present disclosure relate to the field of vehicle power systems.

### BACKGROUND

Solar and other types of vehicle-based power harvesting are becoming more and more prevalent. For example, various passenger cars, trailers and trucks are not outfitted with solar panels. Other energy collection devices such as regenerative braking and wind may be added.

With more and more electrical systems being utilized in vehicles, there are now many onboard systems that require recharging. At times, the output of the vehicle alone is not sufficient to meet the needs of all the battery-operated systems. Energy collection devices such as solar, regenerative braking, and wind may supplement the charging capabilities of the vehicle. With increasing recharging demand, it is desirable to utilize a means of taking in multiple supplemental power sources and to efficiently distribute the collected power to various systems that require charging.

The above information disclosed in this Background section is only for enhancement of understanding of the background of the invention and therefore it may contain information that does not form the prior art that is already known to a person of ordinary skill in the art.

### SUMMARY

Aspects of embodiments of the invention are directed toward a power distribution system capable of collecting and aggregating electrical power from a multitude of supplemental sources and efficiently distributing the collected power in real time among the different vehicle onboard systems that are in need of charging. In some embodiments, the power distribution system can prioritize charging of certain onboard systems over others according to a priority list or predetermined logic. In some examples, the prioritization of aggregated output will allow more mission critical systems to receive power first, and once those systems are satiated (e.g., sufficiently charged), the aggregated energy is distributed to the next system in priority.

According to some embodiments of the present disclosure, there is provided a power distribution system including: a plurality of battery chargers configured to charge a plurality of batteries and to detect states of charge of the plurality of batteries; and a power distribution circuit (PDC) configured to receive and aggregate electrical power from a plurality of power sources, to receive the states of charge from the battery chargers, and to direct aggregated power to a battery charger of the plurality of battery chargers based on the states of charge from the battery chargers.

In some embodiments, the battery chargers are configured to detect states of health of the plurality of batteries and to communicate the states of health to the power distribution circuit.

In some embodiments, the power distribution circuit is configured to direct aggregated power to the battery charger further based on the states of health of the plurality of batteries.

In some embodiments, the power distribution circuit is configured to direct aggregated power to the battery charger further based on a prioritized order of the plurality of batteries.

In some embodiments, the power distribution circuit includes: a PDC communication circuit configured to receive the states of charge from the plurality of battery chargers via a protocol; an aggregator configured to aggregate electrical power from the plurality of power sources to generate the aggregate electrical power at an output of the aggregator for supplying to the plurality of battery chargers; a switching circuit configured to selectively couple the output of the aggregator to one of the battery chargers based on a control signal; and a PDC controller configured to generate the control signal based on the states of charge.

In some embodiments, the protocol is a serial, an SAE (Society of Automotive Engineers standard) J1939, an SAE J1708, or an ethernet protocol.

In some embodiments, the aggregator includes a plurality of diodes, each of the diodes having a cathode electrode coupled to a corresponding one of the plurality of power sources and an anode electrode coupled to the output of the aggregator.

In some embodiments, the switching circuit includes a plurality of switches, each one of the switches including a first terminal coupled to the output of the aggregator and a second terminal coupled to a corresponding one of the battery chargers, the control signal includes a plurality of switch control signals, each one of the control signals corresponding to one of the plurality of switches, and each one of the plurality of switches is configured to electrically connect the output of the aggregator to the corresponding one of the battery chargers based on a corresponding one of the plurality of switch control signals.

In some embodiments, the PDC controller is configured to generate the control signal based on a prioritized order of the plurality of batteries.

In some embodiments, the PDC communication circuit is configured to wirelessly receive the prioritized order of the plurality of batteries from an external user device.

In some embodiments, the plurality of power sources includes at least one of a solar panel, a wind turbine, a power line from a tow vehicle, a liftgate charger for receiving power from the power line, a magnetic motor, a thermoelectric pad in a braking system, a piezo-electric generator, and regenerative breaking.

In some embodiments, the plurality of batteries includes at least one of a liftgate battery, a reefer battery, a telematics battery, a trailer traction motor battery, and a pallet jack battery.

In some embodiments, a battery charger (BC) of the plurality of battery chargers includes: a charging circuit configured to charge a battery of the plurality of batteries based on electrical power received from the power distribution circuit; a sensing circuit configured to sense at least one of an input current, a voltage, and a temperature of the battery; a BC controller configured to determine a state of charge (SOC) of the battery based on the at least one of the input current, the voltage, and the temperature of the battery, and to control operation of the charging circuit; and a BC communication circuit configured to communicate the SOC to the power distribution circuit via a protocol.

In some embodiments, the BC controller is configured to further determine a state of health (SOH) of the battery based the at least one of the input current, the voltage, and the temperature of the battery.

In some embodiments, the sensing circuit includes: a current sensor configured to measure the input current of the battery; a voltage sensor configured to measure the voltage of the battery; and a temperature sensor configured to measure the temperature of the battery.

According to some embodiments of the present disclosure, there is provided a method of distributing power to a plurality of batteries by a power distribution system, the method including: receiving and aggregating, by a power distribution circuit (PDC) of the power distribution system, electrical power from a plurality of power sources; receiving, by the power distribution circuit, states of charge of the plurality of batteries from a plurality of battery chargers of the power distribution system, each of the plurality of battery chargers being coupled to a corresponding one of the plurality of batteries; and routing, by the power distribution circuit, aggregated power to a battery charger of the plurality of battery chargers based on the states of charge from the battery chargers.

In some embodiments, the method further includes: receiving, by the power distribution circuit, states of health of the plurality of batteries from the plurality of battery chargers, wherein the routing the aggregated power is further based on the states of health of the plurality of batteries.

In some embodiments, the routing the aggregated power is further based on a prioritized order of the plurality of batteries.

In some embodiments, the method further includes: receiving the prioritized order of the plurality of batteries from an external user device.

In some embodiments, the plurality of power sources includes at least one of a solar panel, a wind turbine, a power line from a tow vehicle, a liftgate charger for receiving power from the power line, a magnetic motor, a thermoelectric pad in a braking system, a piezo-electric generator, and regenerative breaking, and wherein the plurality of batteries includes at least one of a liftgate battery, a reefer battery, a telematics battery, a trailer traction motor battery, and a pallet jack battery.

### BRIEF DESCRIPTION OF THE DRAWINGS

The accompanying drawings, together with the specification, illustrate exemplary embodiments of the invention, and, together with the description, serve to explain aspects of embodiments of the invention. In the drawings, like reference numerals are used throughout the figures to reference like features and components. The figures are not necessarily drawn to scale. The above and other features and aspects of the invention will become more apparent by the following detailed description of illustrative embodiments thereof with reference to the attached drawing, in which:

FIG. 1 is a block diagram of a vehicle power distribution system (PDS) within a vehicle, according to some exemplary embodiments of the present disclosure.

FIG. 2 is a block diagram of the vehicle power distribution system including a power distribution circuit and a plurality of battery chargers, according to some exemplary embodiments of the present disclosure.

FIG. 3 is a block diagram illustrating the battery charger, according to some example embodiments of the present disclosure.

FIG. 4 illustrates a flow diagram of a process of distributing power to a plurality of batteries by the power distribution system, according to some example embodiments of the present disclosure.

### DETAILED DESCRIPTION

The detailed description set forth below is intended as a description of example embodiments of the invention, and is not intended to represent the only forms in which the invention may be constructed or utilized. The description sets forth the features of the invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

In some embodiments, the power distribution system (PDS) includes two components: an intelligent power distribution circuit (PDC) and a battery charger. The purpose of the PDS is to intelligently distribute electrical power from a variety of sources, such as solar, wind, motion/vibration or other sources harvested by the vehicle. With the ever-growing electrification in the vehicle market the use of renewable energy sources located on the vehicle are becoming more common. PDS provides a way to manage the power storage needs of all the systems on board the vehicle/trailer with the power harvesting occurring on the vehicle/trailer. Moreover, the PDS present a way to reduce waste of excess power generation.

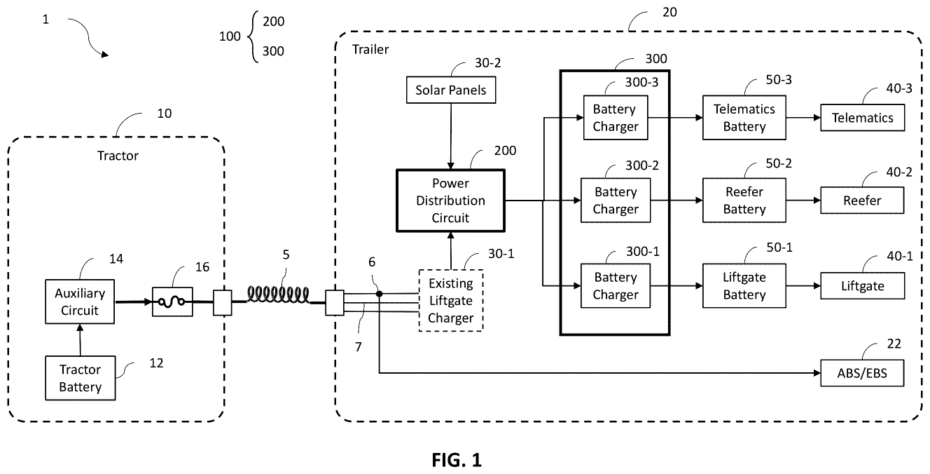

FIG. 1 is a block diagram of a vehicle power distribution system (PDS) within a vehicle, according to some exemplary embodiments of the present disclosure.

Referring to FIG. 1, the vehicle (e.g., a heavy duty vehicle) 1 may include a tractor (or a towing vehicle) 10 and a trailer (or a towed vehicle) 20.

In some embodiments, the electrical system of the tractor 10 of the vehicle 1 supplies electrical power to the electrical system of the trailer 20 via a connector (e.g., a SAE (Society of Automotive Engineers standard) J560 connector) 5. The connector 5 includes an auxiliary power line 6 (e.g., the blue wire of the SAE J560 connector), which generally provides power to the anti-lock braking system (ABS) or the electronic braking system (EBS) 22 of the trailer 20, is coupled to the tractor (e.g., at an SAE J560 connection at the back of the tractor 10), and may supply a current of up to about 30 A to the electrical system of the trailer 20 (e.g., via an auxiliary wire (or blue wire) of the J560 connection). The connector 5 also includes a ground line 7 (e.g., corresponding to the SAE J560 pin #1), which acts as the common ground reference for many if not all of the electrical devices at the trailer 20 including the power distribution circuit 200, the battery chargers 300, the batteries 50-1 to 50-3, the liftgate 40-1, the reefer 40-2, and the telematics device 40-3.

The connector 5 is indirectly coupled to the tractor battery 12, that is, the connector 5 is electrically routed to the tractor battery 12 through an auxiliary circuit 14, which may include, for example, a dashboard of a tractor 10 and its constituents components such as, an internal electronic control module (ECU) system, and other components such as fuses, and relays, and/or the like. As such, the indirect connection between the tractor battery 12 and the connector 5 is also switchable, and may only be established when, for example, the ignition of the tractor 102 is ON and the tractor engine is ON, and/or when another switch (e.g., a bypass switch) is ON to enable power to be supplied to the second connector without having the keys in the tractor 10. The electrical system of the tractor 10 may further include a fuse 16 (e.g., a 30 A resettable fuse) to ensure that the current through the connector 5 does not exceed a line current limit (of, e.g., 30 A).

In some examples, the electrical systems of the tractor 10 and trailer 20 may also be connected to one another by a secondary connector (e.g., a single/multi-pole stinger cord) that may provide a direct connection between the tractor battery 12 and the trailer 20.

In some examples, the trailer 20 may include a liftgate charger (e.g., a preinstalled liftgate charger) 30-1 that, in the related art, could be used to charge a liftgate battery based on power draw from the connector 5.

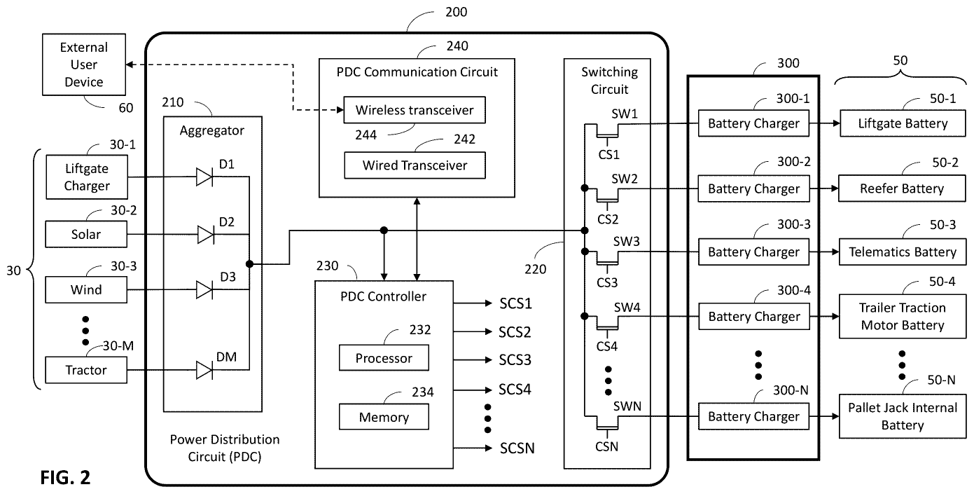

In some embodiments, the trailer 20 further includes one or more auxiliary power sources, such as solar panels 30-2, which act as independent sources of electrical energy for powering the various components of the trailer 20, and supplement the electrical power drawn from the tractor 10 through the connector 5 as, in some examples, power drawn from the tractor 10 may not be sufficient for charging the batteries within the trailer 20. For example, while the connector 5 may be able to provide a current of about 30 A, power transmission through the connector 5 may be available only when the keys of the vehicle 1 are in the ignition, which, when left unattended, may make the vehicle 1 susceptible to theft when idle and lead to inadvertent draw of other auxiliary loads, such as the tractor's ECU, air conditioning unit, heating unit, microwave, and/or the like. By utilizing one or more auxiliary power sources (e.g., the solar panels 30-2), it may be possible to ensure that the various batteries and components of the trailer 20 are adequately charged and powered and are ready to use when needed. The auxiliary power sources will be further described with reference to FIG. 2.

According to some examples, the trailer 20 may be equipped with a number of auxiliary loads including a liftgate 40-1 powered by a liftgate battery 50-1, a refrigerator (also referred to as a reefer) 40-2 powered by a reefer battery 50-2, a telematics device (also referred to as a telematics gateway) 40-3 powered by a telematics battery 50-3, and/or the like. The liftgate 40-1 is a hydraulic platform on the rear of the trailer 20 that allows cargo to be lifted from the ground to the tailgate, or vice versa. The reefer 40-2 is an active cooling system that helps maintain the temperature of cargo in the trailer once loaded. In some examples, the reefer 40-2 may be a diesel electric reefers or a fully electric reefer under trailer power pack. The telematics device 40-3 may communicate various information to the driver and/or the dispatch/fleet manager. In some examples, the telematics device 40-3 may use a cellular connection or a Wi-Fi connection to communicate with a remote server (e.g., a remote server on the cloud), which may compile and further process the received data. Further auxiliary loads will be described with reference to FIG. 2.

According to some embodiments, the power distribution system 100 acts as an intermediary between a plurality of power sources (e.g., renewable energy collection systems) 30 and the plurality of battery storage 50 corresponding to the onboard electronic systems of the vehicle 1. In some embodiments, the power distribution system 100 includes a power distribution circuit (PDC) 200 and a plurality of battery chargers 300 corresponding one-to-one to the plurality of batteries 50. The battery chargers 300 are configured to charge the batteries 50, to detect the states of charge (SOCs) and/or the states of health (SOHs) of the batteries 50, and to report the SOCs and/or SOHs to the power distribution circuit 200. According to some embodiments, the power distribution circuit 200 is an intelligent system configured to receive and aggregate electrical power from the different power sources 30, and to direct the aggregated power to a battery charger 300 based on at least one of the SOCs of the batteries 50, the SOHs of the batteries 50, and a programmable hierarchy of the batteries 50 or a set logic, which may be programmed by a user either over the air via Bluetooth or any other RF based method such as wifi, or by existing vehicle hardwire protocols and methods.

In some embodiments, the purpose of the programming is to assign priorities to the output of the power distribution circuit 200 so that more mission critical systems can receive either all or a greater share of the energy (e.g., renewable energy) being produced by the power sources 30. According to some embodiments, the power distribution circuit 200 first charges the highest priority onboard system, and once that is complete, the power distribution circuit 200 then proceeds to deliver energy to the next critical system in the programmed hierarchy and move down the priority list as each individual system's needs are met. In some embodiments, the programming may also specify the proportion output energy that is to be allocated to each onboard system. Thus, the power distribution system 100 may charge more than one onboard battery at a time.

Each load system attached to the output of the power distribution circuit 200 may have different needs in the form of battery chemistry (e.g., lead-acid, AGM (absorbent glass mat), lithium-ion, etc.), operating temperature, charging rate, and other parameters. As such, in some embodiments, the power distribution circuit 200 utilizes the battery chargers 300 to not only act as a charging circuit tailored to the battery systems' needs, but also to monitor the state of charge and health of the batteries. The battery chargers 300 may relay that information to the power distribution circuit 200 to aid in its task of delivering energy on the preprogramed priority basis. This will also aid in distributing harvested energy on a priority basis where battery health is a factor. For example, it is not desirable to distribute energy to a failing or unhealthy storage system, as it may result in energy waste.

FIG. 2 is a block diagram of a vehicle power distribution system (PDS) including the power distribution circuit 200 and the plurality of battery chargers 300, according to some exemplary embodiments of the present disclosure.

Referring to FIG. 2, according to some embodiments, the power distribution circuit 200 includes an aggregator 210, a switching circuit 220, a PDC controller (also referred to as a first or primary controller) 230, and a PDC communication circuit (also referred to as a first or primary controller) 240.

In some embodiments, the aggregator 210 is configured to aggregate electrical power from the plurality of power sources 30 to generate aggregate electrical power at the output of the aggregator 210 for supplying to the plurality of battery chargers 300. In some examples, the plurality of power sources 30 may include M different sources (M being an integer greater than 1) such as the liftgate charger 30-1 that is powered through the auxiliary power line 6 by the tractor 10, one or more solar panels 30-2 mounted to the roof of the trailer 20, one or more wind turbines 30-3 attached to the vehicle 1, the tractor 10/30-M (e.g., the auxiliary power line 6 of the connector 5), a magnetic motor, a thermoelectric pad in a braking system, a piezo-electric generator, and regenerative breaking, and/or the like. In some embodiments, the aggregator 210 a plurality of diodes D1-DM each of which has a cathode electrode coupled to a corresponding one of the plurality of power sources 30 and an anode electrode that is coupled to output of the aggregator 210. This configuration allows the aggregator 210 to not only aggregate power from the various sources 30 but to also prevent backflow of current from the output of the aggregator 210 to any of the power sources 30.

According to some embodiments, the switching circuit 220 is configured to selectively couple the output of the aggregator 210 to one of battery chargers 50 based on a control signal from the PDC controller 230, which may include a plurality of switch control signals SCS1 to SCSN. In some embodiments, the switching circuit 220 includes a plurality of switches SW1 to SWN (N being an integer greater than 1). Each switch SW includes a first terminal coupled to the output of the aggregator 210 and a second terminal coupled to a corresponding one of the battery chargers 300, and is configured to electrically connect the output of the aggregator 210 to the corresponding one of the battery chargers 300 based on a corresponding one of the switch control signals SCS.

The battery charger 300 may then charge the corresponding battery 50. In some examples, the batteries 50 may include a liftgate battery 50-1, a reefer battery 50-2, a telematics battery 50-3, a trailer traction motor battery 50-4, a pallet jack battery 50-N, and/or the like.

In some examples, each switch SW may include a transistor, such as a metal-oxide semiconductor field-effect transistor (MOSFET), which may be an n-channel MOSFET (NMOS) or a p-channel MOSFET (PMOS) transistor). Each switch SW may also include a plurality of transistors coupled in parallel to reduce on-resistance.

According to some embodiments, the PDC controller 230 is configured to generate the control signal, which includes the plurality of switch control signals SCS1 to SCSN, based on at least one of the SOCs of the batteries 50, the SOHs of the batteries 50, and a programmed hierarchy of the batteries 50. In some embodiments, the programmed hierarchy is a prioritized order of the batteries 50, which lists the batteries 50-1 to 50-N that are equipped in the vehicle 1 based on their order of importance (e.g., importance in terms of the proper functioning of the vehicle 1). For example, when temperature-sensitive cargo is being carried by the trailer 20 the reefer battery 50-2 may have the highest priority and the pallet jack internal battery 50-N, which is not critical to the operation of the vehicle 1, may have the lowest priority in the prioritized order stored at the PDC controller 230.

In embodiments in which the PDC controller 230 utilizes a priority list of batteries 50, when the PDC controller 230 determines, based on the reported SOCs, that a group of the batteries 50 (e.g., the liftgate battery 50-2 and the pallet jack internal battery 50-N) have charge levels that are below a threshold (e.g., 80% or 90% of capacity), the controller 230 generates the control signal to first charge only the highest-priority battery 50 from within the group (e.g., the liftgate charger battery 50-1) by turning on the corresponding switch (while turning off the remaining switches), and once the SOC of that battery 50 reaches the threshold, to change the control signal to charge only the second-highest-priority battery 50 from within the group (e.g., the pallet jack internal battery 50-N), and to proceed in a similar manner down the priority list. For example, when the PDC controller 230 determines that the liftgate battery 50-2 and the pallet jack internal battery 50-N have charge levels that are below the threshold, the controller 230 activates the first switch control signal SCS1 to turn on (e.g., close) the first switch SW1 and deactivates the remaining switch control signals to turn off (and open) the remaining switches SW. This allows the first battery charger 300-1 to first only charge the liftgate battery 50-1. The PDC monitors SOC reports from the first battery charger 300-1 and, when the SOC of the liftgate battery 50-1 reaches the desired threshold, the PDC controller activates the Nth switch control signal SCSN to turn on (e.g., close) the Nth switch SWN and deactivates the remaining switch control signals to turn off (and open) the remaining switches SW. This then allows the Nth battery charger 300-N to only charge the pallet jack internal battery 50-N until it's SOC reaches the desired level.

In some embodiments, the SOHs of the batteries 50 aid in distributing aggregated energy on a priority basis where battery health is a factor. For example, it may not be desirable to distribute energy to a failing or unhealthy battery 50 as it may result in energy waste. In some examples, the user can use the battery chargers 300 as a battery-specific charging circuit and turn off the health monitoring if they so desire. This ability may be via the programming methodologies described for the power distribution circuit 200.

While the examples above describe the PDC controller 230 as charging only one battery at a time, embodiments of the present disclosure are not limited thereto. For example, the PDC controller 230 may activate two or more switch control signals SCS to charge two or more batteries concurrently (e.g., simultaneously). In some embodiments, the PDC controller 230 may allocate a proportion of the aggregated power to each of the two or more batteries. This may be programmed by a user.

The controller 230 may include a processor (or processing circuit) 232 and an internal memory 234 having stored thereon instruction that when executed by the processor 232 cause the processor to perform the actions described herein with reference to the controller 230. For example, the memory 234 may store the SOCs and/or the SOHs received from the battery chargers 300 and the programmed hierarchy of the batteries 50 for use by the processor 232. The term “processor” or “processing circuit” is used herein to include any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general purpose hardware, such as a CPU, configured to execute instructions stored in a non-transitory storage medium. A processing circuit may be fabricated on a single printed wiring board (PWB) or distributed over several interconnected PWBs. A processing circuit may contain other processing circuits; for example, a processing circuit may include two processing circuits, an FPGA and a CPU, interconnected on a PWB.

In some embodiments, the PDC communication circuit 240 is configured to receive the states of charge and/or the states of health from the plurality of battery chargers using a communication protocol. The PDC communication circuit 240 may include a wired transceiver 242 coupled to the CAN bus of the trailer 20, which is capable of transmitting and receiving messages via the CAN bus. For example, wired transceiver 242 is configured to receive the SOC/SOH data reported by the battery charger 300 and to transmit this information to the PDC controller 230 for determining which battery 50 to charge. The CAN network may be based on SAE (Society of Automotive Engineers standard) J1939 and ISO 11898-2. However, embodiments of the present disclosure are not limited to the CAN bus network, and any suitable communication protocol, such as a serial, SAE J1708, and Ethernet, and corresponding network may be utilized.

The PDC communication circuit 240 may also include a wireless transceiver 244 configured to wirelessly send data to and receive data from an external user device 60 (e.g., a mobile phone or tablet). The wireless transceiver 244 may be configured to communicate over wifi and/or bluetooth. This allows a user to wirelessly program/set the hierarchy of the batteries 50. Additionally, the wireless transceiver 244 may also allow the external user device 60 to receive battery prognostic information (such as SoC and SOH data) from the power distribution circuit 200.

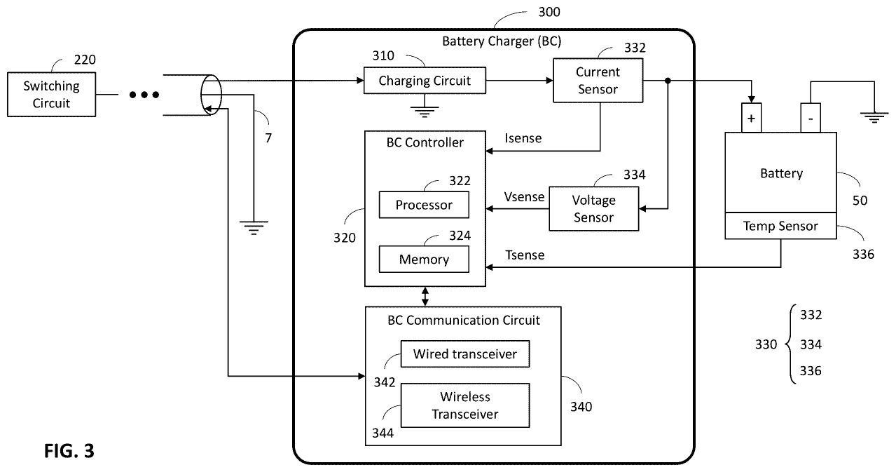

FIG. 3 is a block diagram illustrating the battery charger 300, according to some example embodiments of the present disclosure.

Referring to FIG. 3, in some embodiments, the battery charger (BC) 300 act as a charging circuit tailored to the corresponding battery's needs, which may be based on the battery's chemistry (e.g., lead-acid, AGM (absorbent glass mat), lithium-ion, etc.), operating temperature, charging rate, and other parameters. In some embodiments, the power distribution circuit 200 includes a charging circuit 310, a controller 320, a sensing circuit 330, and a BC communication circuit 340.

In some embodiments, the charging circuit 310 is configured to charge a battery 50 based on electrical power received from the power distribution circuit 200. The charging circuit 310 may include a DC-DC converter, such as a boost regulator, a buck regulator, a buck-boost regulator, or the like. The charging circuit 310 may be able to regulate an input ranging from about 9 V to about 46 V to a desired output voltage of, for example, about 14.4 V. In some examples, the charging circuit 310 may provide galvanic isolation and may be 95% or more efficient in the stated operational range.

The sensing circuit 330 is configured to sense at least one of an input current, a voltage, and a temperature of the battery 50, and includes a current sensor 332, a voltage sensor 334. In some examples, the battery charger 300 may include or interface with a temperature sensor 336.

The current sensor 332 measures the input current (e.g., the instantaneous input current) to the battery 50 and reports the sensed current to the BC controller 320 for processing. The current sensor 332 may be a hall effect current sensor 332, a resistive sensor that utilizes a shunt resistor and a high speed amplifier, or the like. The voltage sensor 334 measures the input voltage of the battery 50 and reports the measurement to the BC controller 320 for processing.

In some examples, the BC controller 320 may also have the ability to monitor the temperature of the battery 50 by virtue of a temperature sensor 336 (e.g., a CAN-based temperature sensor) that may be attached to battery 50. The temperature sensor may be a negative temperature coefficient (NTC) thermistor, a resistance temperature detector (RTD), a thermocouple, a semiconductor-based sensor, or the like.

The BC controller 320 may utilize the sensed current (Isense), the sensed voltage (Vsense), and/or the sensed temperature (Tsense) to determine (e.g., estimate) the state of charge (SOC) and/or the state of health (SOH) of the battery 50 and to report the SOC and/or the SOH to PDC controller 230 of the power distribution circuit 200 via the BC communication circuit 340. In some examples, the BC controller 320 estimates SOC and SOH by utilizing a coulomb counting algorithm or a variation thereof. However, embodiments of the preset disclosure are not limited thereto, and any suitable estimation method such as a voltage measurement method or the Kalman filter method may be employed. The BC controller 320 also controls the internal operations of the battery charger 300.

The BC communication circuit 340 is configured to communicate the SOC to the power distribution circuit via a protocol described above with respect to the PDC communication circuit 240. The BC communication circuit 340 may include a wired transceiver 342 and a wireless transceiver 343. The BC communication circuit 340 may be the same or substantially the same as the PDC communication circuit 240, as such a description thereof may not be repeated here.

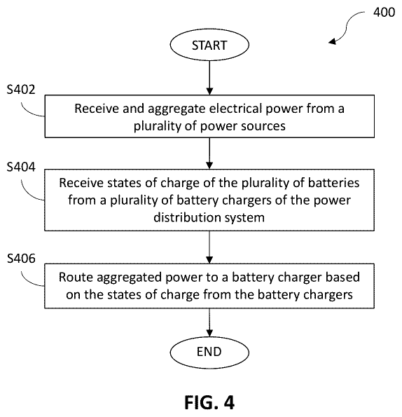

FIG. 4 illustrates a flow diagram of a process 400 of distributing power to a plurality of batteries 50 by the power distribution system 100, according to some example embodiments of the present disclosure.

In some embodiments, the power distribution circuit (PDC) 200 of the power distribution system 100 receives and aggregates electrical power from a plurality of power sources 30 (S402).

In some embodiments, the power distribution circuit 200 receives at least states of charge (SOCs) of the plurality of batteries 50 from a plurality of battery chargers 300 of the power distribution system (S404). In some examples, the power distribution circuit 200 also receives the states of health of the plurality of batteries 50 from the plurality of battery chargers 300.

According to some embodiments, the power distribution circuit 200 routs the aggregated power to a battery charger 300 based at least on the states of charge from the battery chargers 300 (S406). In some examples, the power distribution circuit 200 also routes the aggregated power is further based on the states of health of the plurality of batteries and/or a prioritized order of the plurality of batteries.

Accordingly, as described above, the power distribution system provides harvested energy in real time to mission critical systems in a priority order as to their significance in vehicle safety and business operations. It reduces waste of excess harvested energy, and makes available harvested energy to systems that may previously not have had access to an alternative power source.

While some of the embodiment of the present disclosure are described with respect to a tractor (or a towing vehicle) 10 and a trailer (or a towed vehicle) 20, embodiments of the present disclosure are not limited thereto. For example, the power distribution may be used in any vehicle or, more broadly, any system where it is desired that power from multiple power sources be intelligently routed a plurality of electrical loads.

It should be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and equivalents thereof.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

The terminology used herein is for the purpose of describing particular embodiments and is not intended to be limiting of the inventive concept. It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

As used herein, the singular forms “a” and “an” are intended to include the plural forms as well, unless the context clearly indicates otherwise. It will be further understood that the terms “include,” “including,” “comprises,” “comprising,” “has,” “have,” and “having,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. For example, the expression “A and/or B” denotes A, B, or A and B. Expressions such as “one or more of” and “at least one of,” when preceding a list of elements, modify the entire list of elements and do not modify the individual elements of the list. For example, the expression “one or more of A, B, and C,” “at least one of A, B, or C,” “at least one of A, B, and C,” and “at least one selected from the group consisting of A, B, and C” indicates only A, only B, only C, both A and B, both A and C, both B and C, or all of A, B, and C.

Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, “in contact with”, “in direct contact with”, or “immediately adjacent” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art.

The terms “use,” “using,” and “used” may be considered synonymous with the terms “utilize,” “utilizing,” and “utilized,” respectively.

When one or more embodiments may be implemented differently, a specific process order may be performed differently from the described order. For example, (i) the disclosed operations of a process are merely examples, and may involve various additional operations not explicitly covered, and (ii) the temporal order of the operations may be varied.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The battery charger and/or any other relevant devices or components according to embodiments of the invention described herein may be implemented utilizing any suitable hardware, firmware (e.g., an application-specific integrated circuit), software, or a suitable combination of software, firmware, and hardware. For example, the various components of the controller may be formed on one integrated circuit (IC) chip or on separate IC chips. Further, the various components of the controller may be implemented on a flexible printed circuit film, a tape carrier package (TCP), a printed circuit board (PCB), or formed on a same substrate as the controller. Further, the various components of the controller may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the invention.

What is claimed is:

1. A power distribution system comprising:
a plurality of battery chargers configured to charge a plurality of batteries and to detect states of charge of the plurality of batteries; and
a power distribution circuit (PDC) configured to receive and aggregate electrical power from a plurality of power sources, to receive the states of charge from the battery chargers, and to direct aggregated power to a battery charger of the plurality of battery chargers based on the states of charge from the battery chargers.

2. The power distribution system of claim 1, wherein the battery chargers are configured to detect states of health of the plurality of batteries and to communicate the states of health to the power distribution circuit.

3. The power distribution system of claim 2, wherein the power distribution circuit is configured to direct aggregated power to the battery charger further based on the states of health of the plurality of batteries.

4. The power distribution system of claim 3, wherein the power distribution circuit is configured to direct aggregated power to the battery charger further based on a prioritized order of the plurality of batteries.

5. The power distribution system of claim 1, wherein the power distribution circuit comprises:
a PDC communication circuit configured to receive the states of charge from the plurality of battery chargers via a protocol;
an aggregator configured to aggregate electrical power from the plurality of power sources to generate the aggregate electrical power at an output of the aggregator for supplying to the plurality of battery chargers;
a switching circuit configured to selectively couple the output of the aggregator to one of the battery chargers based on a control signal; and
a PDC controller configured to generate the control signal based on the states of charge.

6. The power distribution system of claim 5, wherein the protocol is a serial, an SAE (Society of Automotive Engineers standard) J1939, an SAE J1708, or an ethernet protocol.

7. The power distribution system of claim 5, wherein the aggregator comprises a plurality of diodes, each of the diodes having a cathode electrode coupled to a corresponding one of the plurality of power sources and an anode electrode coupled to the output of the aggregator.

8. The power distribution system of claim 5, wherein the switching circuit comprises a plurality of switches, each one of the switches comprising a first terminal coupled to the output of the aggregator and a second terminal coupled to a corresponding one of the battery chargers,
wherein the control signal comprises a plurality of switch control signals, each one of the switch control signals corresponding to one of the plurality of switches, and
wherein each one of the plurality of switches is configured to electrically connect the output of the aggregator to the corresponding one of the battery chargers based on a corresponding one of the plurality of switch control signals.

9. The power distribution system of claim 5, wherein the PDC controller is configured to generate the control signal based on a prioritized order of the plurality of batteries.

10. The power distribution system of claim 9, wherein the PDC communication circuit is configured to wirelessly receive the prioritized order of the plurality of batteries from an external user device.

11. The power distribution system of claim 1, wherein the plurality of power sources comprises at least one of a solar panel, a wind turbine, a power line from a tow vehicle, a liftgate charger for receiving power from the power line, a magnetic motor, a thermoelectric pad in a braking system, a piezo-electric generator, and regenerative breaking.

12. The power distribution system of claim 1, wherein the plurality of batteries comprises at least one of a liftgate battery, a reefer battery, a telematics battery, a trailer traction motor battery, and a pallet jack battery.

13. The power distribution system of claim 1, wherein a battery charger (BC) of the plurality of battery chargers comprises:
a charging circuit configured to charge a battery of the plurality of batteries based on electrical power received from the power distribution circuit;
a sensing circuit configured to sense at least one of an input current, a voltage, and a temperature of the battery;
a BC controller configured to determine a state of charge (SOC) of the battery based on the at least one of the input current, the voltage, and the temperature of the battery, and to control operation of the charging circuit; and
a BC communication circuit configured to communicate the SOC to the power distribution circuit via a protocol.

14. The power distribution system of claim 13, wherein the BC controller is configured to further determine a state of health (SOH) of the battery based the at least one of the input current, the voltage, and the temperature of the battery.

15. The power distribution system of claim 13, wherein the sensing circuit comprises:
a current sensor configured to measure the input current of the battery;
a voltage sensor configured to measure the voltage of the battery; and
a temperature sensor configured to measure the temperature of the battery.

16. A method of distributing power to a plurality of batteries by a power distribution system, the method comprising:
receiving and aggregating, by a power distribution circuit (PDC) of the power distribution system, electrical power from a plurality of power sources;
receiving, by the power distribution circuit, states of charge of the plurality of batteries from a plurality of battery chargers of the power distribution system, each of the plurality of battery chargers being coupled to a corresponding one of the plurality of batteries; and
routing, by the power distribution circuit, aggregated power to a battery charger of the plurality of battery chargers based on the states of charge from the battery chargers.

17. The method of claim 16, further comprising:
receiving, by the power distribution circuit, states of health of the plurality of batteries from the plurality of battery chargers,
wherein the routing the aggregated power is further based on the states of health of the plurality of batteries.

18. The method of claim 16, wherein the routing the aggregated power is further based on a prioritized order of the plurality of batteries.

19. The method of claim 18, further comprising:
receiving the prioritized order of the plurality of batteries from an external user device.

20. The method of claim 16, wherein the plurality of power sources comprises at least one of a solar panel, a wind turbine, a power line from a tow vehicle, a liftgate charger for receiving power from the power line, a magnetic motor, a thermoelectric pad in a braking system, a piezo-electric generator, and regenerative breaking, and
wherein the plurality of batteries comprises at least one of a liftgate battery, a reefer battery, a telematics battery, a trailer traction motor battery, and a pallet jack battery.
